(19) United States
(12) Patent Application Publication
(10) Pub. No.: US 2016/0288033 A1
(43) Pub. Date: Oct. 6, 2016

(54) Filter Medium and Filter Element with a Filter Medium

(71) Applicant: MANN+HUMMEL GMBH, Ludwigsburg (DE)

(72) Inventors: Jochen Reyinger, Waiblingen (DE); Sebastian Neubauer, Marbach (DE); Martin Klein, Ludwigsburg (DE); Lars Spelter, Ditzingen (DE)

(21) Appl. No.: 15/186,449

(22) Filed: Jun. 18, 2016

Related U.S. Application Data
(63) Continuation of application No. PCT/EP2014/076642, filed on Dec. 4, 2014.

(30) Foreign Application Priority Data
Dec. 18, 2013 (DE) 10 2013 021 070.4

(51) Int. Cl. B01D 39/14; F02M 37/22; B01D 35/00

(52) U.S. Cl. CPC B01D 39/14; B01D 35/005; F02M 37/22; B01D 2239/025; B01D 2239/0631; B01D 2239/0654; B01D 2239/1233; B01D 2239/1291

(57) ABSTRACT

A filter medium (10) has a first layer of media (12), a second layer of media (18), and at least one third layer of media (20). The second layer of media (18) is arranged behind the first layer of media (12) in the intended flow direction (16) of the filter medium, and the third layer of media (20) is arranged behind the second layer of media (18) in the intended flow direction (16) of the filter medium. The first layer of media (12) has fibers, and the second layer of media (18) has nanofibers. Also disclosed is a filter element (50) which has such a filter medium (10) and the use of such a filter medium (50) as a fuel filter.

### TECHNICAL FIELD

The invention relates to a filter medium for filtering fluids, in particular for filtering liquids such as for example fuels, and to a filter element with such a filter medium, in particular for use as a fuel filter in an internal combustion engine.

### BACKGROUND

Transmission oil filters having a layer of glass fibers covered on both sides by a spunbond nonwoven. The spunbond nonwoven improves the handling of the layer of glass fibers, for example during the process for producing the filter. Multilayer filters for liquids are known in which a meltblown nonwoven is combined with a downstream layer of cellulose-containing filter paper.

The terms meltblown, spunbond, wet-laid and dry-laid layer production, carded nonwoven, filament spunbond nonwoven and cross-laid nonwoven are defined for example in “Vliesstoffe: Rohstoffe, Herstellung, Anwendung, Eigenschaften, Prüfung, [”Nonwovens: Raw Materials, Manufacture, Use, Properties, Testing“] 2nd edition, 2012, Weinheim”, ISBN: 978-3-527-31519-2.

It is known from the field of air filtration that fiber fragments of glass fibre media enter the clean air zone. Such a release can also be observed in the case of glass fibre media coated with spunbond nonwoven laminated during liquid filtration.

In EP 2 039 411 A1 a transmission oil filter is described, wherein a layer of meltblown media downstream of the filtration layer, consisting of a glass fiber medium, is capable of at least substantially reducing the release of glass fibres and thus makes it possible to use a glass fiber medium for filtration.

Furthermore, WO 2008/066813 A2 describes a filter medium which consists of a nanofiber layer and a substrate layer, wherein the nanofiber layer comprises a polymer and the substrate layer for example comprises a spunbond fiber, a cellulose fiber, a meltblown fiber, a glass fiber or mixed forms thereof. Thus good filtration properties of the filter medium are combined with the possibility of folding the filter medium in pleated form in order to produce a filter element without further modifications.

### SUMMARY

The object of the invention is to create a filter medium which has a compact design and reduces the release of glass fiber fragments into the filtered fluid.

A further object of the invention is to create a filter element having such a filter medium which has a compact design and reduces the release of glass fiber fragments into the filtered fluid.

According to one aspect of the invention, in a filter medium comprising a first layer of media, a second layer of media, and at least one third layer of media, wherein the second layer of media is arranged behind the first layer of media in the intended flow direction of the filter medium, and wherein the third layer of media is arranged behind the second layer of media in the intended flow direction of the filter medium, the aforesaid objects are achieved in that the first layer of media has fibers and the second layer of media has nanofibers.

Beneficial configurations and advantages of the invention arise from further claims, the description and the drawing.

A filter medium is proposed which comprises a first layer of media, a second layer of media, and at least one third layer of media, wherein the second layer of media is arranged behind the first layer of media in the intended flow direction of the filter medium, and wherein the third layer of media is arranged behind the second layer of media in the intended flow direction of the filter medium. The first layer of media has fibers, and the second layer of media has nanofibers.

The intended flow direction extends transversely or orthogonally to the first, second and third layers of media. Thus the fluid stream to be filtered flows through all media layers of the filter medium.

When media containing glass fibers are used, an additional barrier coat is advantageous in order to prevent the glass fibers from being washed out, since these have a substantial abrasive effect. Moreover, since layers of glass fibers do not have sufficient rigidity to maintain an imposed fold structure it is advantageous for the workability to provide an additional layer having substantial rigidity in order to enable accordion folding in the filter element. This is typically made of a spunbond layer or a cellulose layer or a mesh. The object of the invention is achieved here by a combination of support stratum and barrier stratum in a filter layer. This filter layer is made for example of non-woven material, in or on which additional nanofibers are applied. The basic material of continuous fibers offers a high air permeability and simultaneously a high rigidity. The basic material can be produced in a two-stage process. In the first production step the extrusion and spinning of the polymer yarn takes place. In this case the core material and sheath material can be specially selected in each case, the core to sheath ratio varies and the overall fiber thickness can be changed. In the second production step the continuous fibers are laid one above the other in up to four fiber layers and are then thermally bonded at the intersections. Thus a very open-pored, three-dimensional non-woven fabric is produced. The additional application of nanofibers to the inflow side of the non-woven fabric ensures deposition of any glass fibers which may be washed out.

By a combination of the functions of rigidity and barrier stratum for glass fibers in one single filter medium a reduction in the overall height of a filter element is achieved. This leads to an increase in the particle holding capacity and the service life. Thus for a given capacity the overall size of the entire filter can be reduced or the filter can be approved for longer change intervals.

Advantageously the second layer of media can have nanofibers with an average fiber diameter between 50 nm and 1,000 nm, preferably between 600 nm and 800 nm, and/or the second layer of media can be formed at least for the most part from nanofibers with an average fiber diameter between 50 nm and 1,000 nm, preferably between 600 nm and 800 nm. Doubling of the fiber diameter of the nanofibers leads to a significantly poorer degree of deposition on glass fiber fragments.

The median value is meant here as the fiber diameter. A median divides a data set, a random sample or a distribution into two halves, so that the value in one half is lower than the median value and is higher in the other half.

Furthermore, it is advantageous if the second layer of media has a weight per unit area between 0.05 and 10 g/m², preferably between 0.1 and 5 g/m². A selection of materials to be used which has proved beneficial comprises polymers, cellulose (for example diacetate), and mineral fibers. If higher weights per unit area of nanofibers are advantageous for preventing the washing out of glass fibers, weights per unit area of more than 10 g/m² are also possible. Mixtures of nanofibers with other fibers, in particular synthetic fibers, are also conceivable.

In an advantageous embodiment the second layer of media can be formed from electrospun nanofibers. Electrospinning is particularly suitable for producing the smallest fibers and threads, for example for use in non-woven filter pads.

The second layer of media can be formed by coating the first layer of media or the third layer of media with nanofibers. In this way the first layer of media or the third layer of media can serve as a carrier medium for the relatively thin and not very inherently stable nanofiber layer.

The first layer of media can advantageously have fibers with an average fiber diameter between 0.2 μm and 4 μm, preferably between 0.5 μm and 4 μm, especially between 0.5 μm and 1 μm. Thus favorable degrees of deposition of the first layer of media of at least 90%, preferably at least 97%, can be achieved for particles having a particle size greater than 4 μm. In this case it is advantageous to use glass fibers, preferably a mixture of short and long fibers. Short fibers may for example comprise cellulose and/or polymers and/or glass, and long fibers may for example comprise meltblown polymers. Mixture ratios of short to long fibers can typically comprise 5% to 80%, preferably 20% to 60% (percentage by volume).

It is also advantageous if at least 5%, preferably at least 30%, more preferably at least 50%, more preferably at least 95% of the first layer of media is formed from glass fibers.

In the preferred case where the first layer of media consists at least predominantly of glass fibers, the proportion of a binder can preferably be between 3 and 20% (percentage by mass).

The first layer of media preferably has a bimodal distribution of the fiber diameters, containing a fine fiber proportion with an average fiber diameter between 0.5 μm and 1 μm and a coarse fiber proportion with an average fiber diameter between 2 μm and 15 μm. The combination of fine and coarser fibers ensures a high degree of particle deposition with simultaneously low differential pressure and high dust storage capacity.

The thickness of the first layer of media is preferably 0.15 to 0.8 mm.

Advantageously, the first layer of media may have a gradient structure of the packing density of the fibers with an increasing packing density in the intended flow direction. In this way first of all larger particles are deposited in strata close to the surface, whereas smaller particles still flow through, but are then also deposited in deeper strata of the first layer of media with increasing packing density. Thus it is possible to achieve an advantageous service life of the filter medium.

The packing density is a measure of the proportion of filter fibers to the depth a layer of media, i.e. the packing density should be understood as the packing density of fibers or filter fibers per unit area or volume. In particular this is the average packing density or the average packing density value of a layer of media.

In the context of this document a gradient is used as value which indicates the rate of change of a variable. The gradient of a packing density indicates for example the rate at which the packing density of a filter medium changes with increasing material depth or material thickness in the flow direction of the filter medium. The packing density increases either due to a decreasing number of fibre interstices or due to a decreasing size of fibre interstices on a section of the depth of a layer of media.

Typically a gradient of the packing density of the first layer of media, from an inlet zone to an outlet zone along the intended flow direction of the fluid to be filtered, can for example exhibit a rise in the average standardized packing density from 0.07 to 0.12.

Furthermore, it is advantageous if at least 50% of the third layer of media is formed of continuous fibers, in order thus to achieve the highest possible rigidity as support for the layer of glass fibers.

The third layer of media may advantageously be formed from a meltblown layer, a spunbond layer or a cellulose layer.

In an advantageous embodiment the third layer of media can form at least one support stratum. Since the nanofibers form a very thin layer and are not sufficiently inherently stable, it is advantageous to support the nanofiber layer by a third layer of media to support and thus to provide the necessary mechanical stability for use in filter operation, in particular in a motor vehicle.

Advantageously the third layer of media can have a degree of deposition for particles having a particle size greater than 4 μm which is lower than a degree of precipitation for particles having a particle size greater than 4 μm of the first layer of media, preferably lower by a factor of less than 2. In this case the degree of deposition is defined according to the ISO 19438:2003 standard.

Furthermore, the third layer of media can have a degree of precipitation for particles having a particle size greater than 4 μm, which is less than 60%, preferably less than 30%. Thus it is ensured that the degree of deposition the third layer of media is not too great will and can consist entirely of particles of dirt.

In particular it is advantageous if the third layer of media has a thickness of at least 0.15 mm and at most 1.5 mm, preferably at most 0.3 mm, in order to achieve the most compact construction possible of a filter medium with a given absorption capacity of the third layer of media.

The determination the thickness for nonwovens usually takes place according to DIN EN ISO 9073-2. Samples are taken at ten different points on a specimen and are examined. The samples can have a size of DIN A5 and are measured at two points in the center of the surface. If no sample of this size are available, smaller samples can also be measured instead. As a result the individual values of the samples as well as an average value together with the variation are specified in the unit mm.

The third layer of media can advantageously be formed from fibers having an average fiber diameter (median value) of at least 1 μm and at most 40 μm, preferably 20 μm, in order thus to achieve the highest possible specific dust collection.

In a further advantageous embodiment a fourth layer of media can be provided, wherein the fourth layer of media is arranged in front of the first layer of media in the intended flow direction and has a degree of deposition for particles having a particle size greater than 4 μm which is lower than the degree of deposition of the first layer of media. Such a fourth layer of media can advantageously achieve a partial preliminary deposition of larger particles, so that the first layer of media can exert its filtration function for longer than if the entire particle load were to impact fully on it.

The fourth layer of media 28 can advantageously have fibers with an average fiber diameter between 0.2 μm and 4 μm, preferably between 0.5 μm and 4 μm. In this case it is advantageous to use glass fibers, preferably a mixture of short and long fibers. Short fibers may for example comprise cellulose and/or polymers and/or glass, and long fibers may for example comprise meltblown polymers. Mixture ratios of short to long fibers can typically comprise 5% to 80%, preferably 20% to 60% (percentage by volume).

It is also advantageous if at least 5%, preferably at least 30%, more preferably at least 50%, more preferably at least 95% of the fourth layer of media is formed from glass fibers.

Advantageously, the fourth layer of media may have a gradient structure of the packing density of the fibers with an increasing packing density in the intended flow direction.

Generally the fourth layer of media can preferably consist of a wet-laid non-woven fabric, a meltblown or or also a medium which is predominantly made up of glass fibers.

The thickness of the fourth layer is preferably between 0.15 and 0.8 mm.

According to a further aspect, the invention relates to a filter element comprising a filter medium, wherein the filter medium is a folded filter medium, and wherein the filter medium comprises a first layer of media, a second layer of media, and at least one third layer of media, wherein the second layer of media is arranged behind the first layer of media in the intended flow direction of the filter medium, and wherein the third layer of media is arranged behind the second layer of media in the intended flow direction of the filter medium. The first layer of media has fibers, and the second layer of media has nanofibers.

According to another aspect, the invention relates to the use of such a filter element as a fuel filter, in particular as a fuel filter of an internal combustion engine.

### BRIEF DESCRIPTION OF THE DRAWINGS

Further advantages arise from the following drawing description. The drawings show exemplary embodiments of the invention. The drawings, the description and the claims contain numerous features in combination. The person skilled in the art will expediently consider the features individually and combine them into meaningful further combinations. Showing by way of example:

FIG. 1 shows a schematic representation of a filter medium with three layers of media according to one embodiment of the invention;

FIG. 2 shows a schematic representation of a filter medium with four layers of media according to a further embodiment of the invention; and

FIG. 3 shows a filter element with a pleated filter medium according to a further exemplary embodiment of the invention.

### DETAILED DESCRIPTION

The same or similar components in the figures are referenced with same reference characters. The figures merely show examples and are not intended to be restrictive.

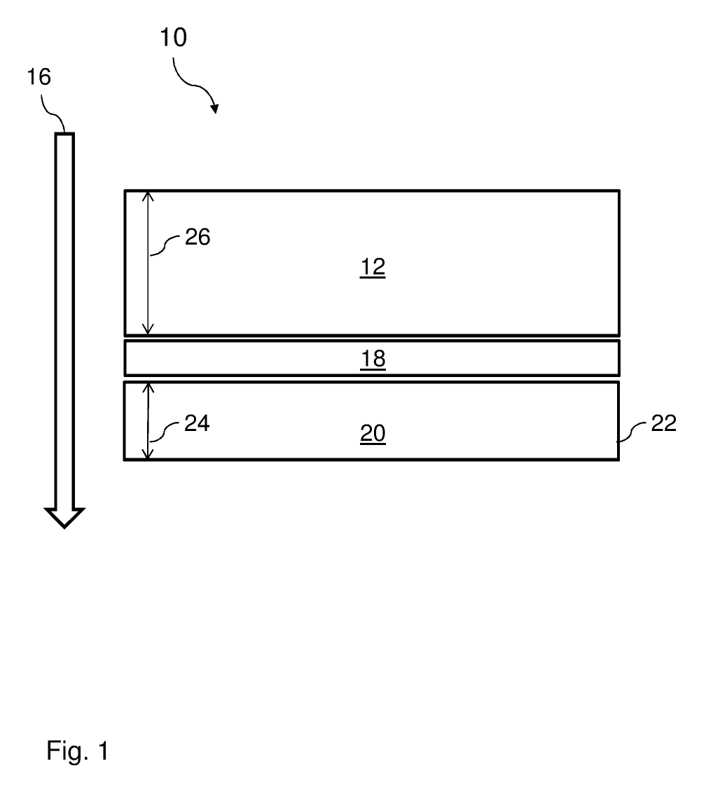

FIG. 1 shows a schematic representation of a filter medium 10 with three media layers 12, 18, 20 according to an exemplary embodiment of the invention. In this case the filter medium 10 comprises a first layer of media 12 and a second layer of media 18, wherein the second layer of media 18 is arranged behind the first layer of media 12 in the intended flow direction 16 of the filter medium, and the third layer of media 20 is arranged behind the second layer of media 18 in the intended flow direction 16 of the filter medium. In the exemplary embodiment the first layer of media 12 has glass fibers, or consists predominantly of glass fibers, whereas the second layer of media 18 has nanofibers and the third layer of media 20 comprises a support layer 22. The second layer of media 18 with nanofibers serves to retain glass fiber fragments washed out from the first layer of media 12. The support layer 22 ensures that the entire composite consisting of the first and second layer of media 12, 18 should also be worked favorably in the manufacturing process, since the first layer of media 12 consisting of glass fibers is difficult to work because of the high flexibility. In this respect the rigidity of the support stratum has a beneficial effect on the workability of the composite of the three layers of media 12, 18, 20.

The third layer of media 20 as support layer 22 typically consists of a spunbond layer or a cellulose layer. The object of the invention is achieved by a combination of barrier stratum and support stratum by two successive layers of media 18, 20. The third layer of media 20 is made for example of non-woven material, in or on which additional nano-fibers are applied. The basic material of continuous fibers offers a high air permeability and simultaneously a high rigidity. Thus a very open-pored, three-dimensional non-woven fabric is produced. The additional application of nanofibers to the inflow side of the non-woven fabric ensures deposition of any glass fibers which may be washed out. The third layer of media 20 may be formed from a meltblown layer, a spunbond layer or a cellulose layer.

The weight per unit area of nanofibers may advantageously be between 0.05 and 10 g/m², preferably 0.1 to 5 g/m². If higher concentrations of nanofibers for preventing the washing out of glass fibers are advantageous, concentrations of more than 10 g/m² are also possible.

Advantageously the third layer of media 20 can have a degree of deposition for particles having a particle size greater than 4 μm which is lower than a degree of precipitation for particles having a particle size greater than 4 μm of the first layer of media 12, preferably lower by a factor of less than 2. Furthermore, the third layer of media 20 can have a degree of precipitation for particles having a particle size greater than 4 μm, which is less than 60%, preferably less than 30%. Furthermore, it is advantageous if at least 50% (percentage by volume) of the at least one support stratum 22 is formed of continuous fibers, in order thus to achieve the highest possible rigidity as support for the layer of glass fibers of the layer of media 12. Advantageously the third layer of media 20 can have a thickness 24 of at least 0.15 mm and at most 1.5 mm, preferably at most 0.3 mm, in order to achieve the greatest possible specific dust collection. The third layer of media 20 may be formed from fibers with an average fiber diameter of at least 1 μm and a maximum of 40 μm, preferably 20 μm.

At least 5%, preferably at least 30%, more preferably at least 50%, more preferably at least 95% of the first layer of media 12 is formed from glass fibers. The first layer of media 12 can have fibers with an average fiber diameter between 0.2 μm and 4 μm, preferably between 0.5 μm and 4 μm.

Advantageously, the first layer of media 12 may have a gradient structure of the packing density of the fibers with an increasing packing density in the intended flow direction 16, in order to achieve an advantageous service life of the filter medium 10.

In an advantageous embodiment the second layer of media 18 can have a nanofiber with a fiber diameter between 50 nm and 1,000 nm, preferably between 600 nm and 800 nm, have, wherein a doubling of the fiber diameter of the nanofibers leads to a significantly poorer degree of deposition of glass fiber fragments. Furthermore, the first layer of media 12 can advantageously have a fiber with a fiber diameter between 50 nm and 1,000 nm, preferably between 600 nm and 800 nm. Thus favorable degrees of deposition of the first layer of media 12 of 90%, preferably greater than 97%, are achieved for particles having a particle size greater than 4 μm. In this case the second layer of media 18 can be formed from electrospun nanofibers. However, the second media layer 18 can also be formed by coating the first layer of media 12 or the third layer of media 20 with nanofibers.

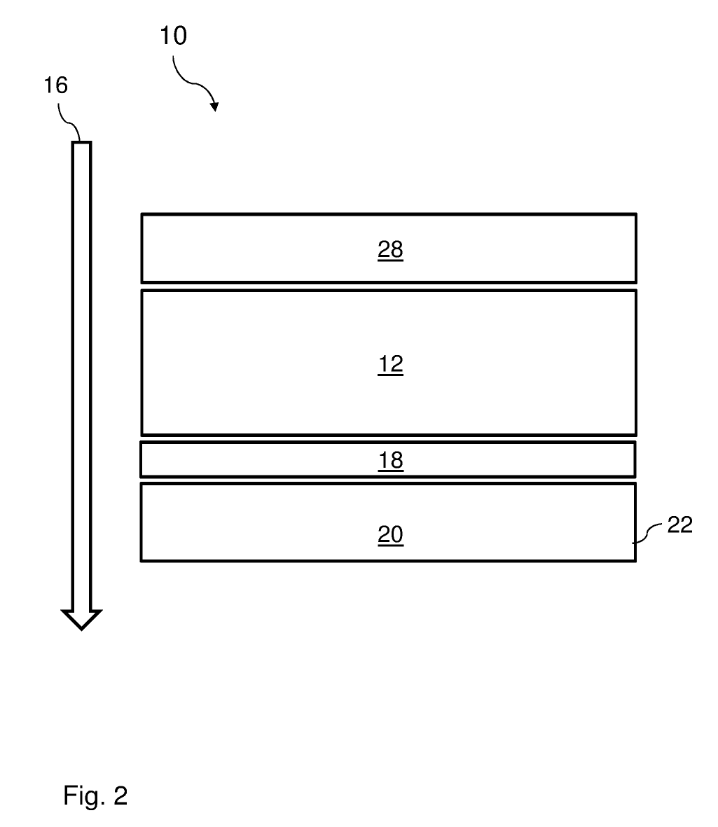

FIG. 2 shows a schematic representation of a filter medium 10 with four layers of media 28, 12, 18, 20 according to a further exemplary embodiment of the invention. The overall construction of the composite is very similar to that described in FIG. 1; only a fourth layer of media 28 is provided, wherein the fourth layer of media 28 is arranged before the first layer of media 12 in the intended flow direction 16 and has a degree of deposition for particles having a particle size greater than 4 pm which is less than the degree of deposition of the first layer of media 12. Such a fourth layer of media 28 can advantageously achieve a partial preliminary deposition of larger particles, so that the first layer of media 12 can exert its filtration function for longer than if the entire particle load were to impact fully on it. At least 5%, preferably at least 30%, more preferably at least 50%, more preferably at least 95% of the fourth layer of media 28 is formed from glass fibers. The fourth layer of media 28 can have fibers with an average fiber diameter between 0.2 μm and 4 μm, preferably between 0.5 μm and 4 μm.

Advantageously, the fourth layer of media 28 may have a gradient structure of the packing density of the fibers with an increasing packing density in the intended flow direction 16, in order to achieve an advantageous service life of the filter medium 10.

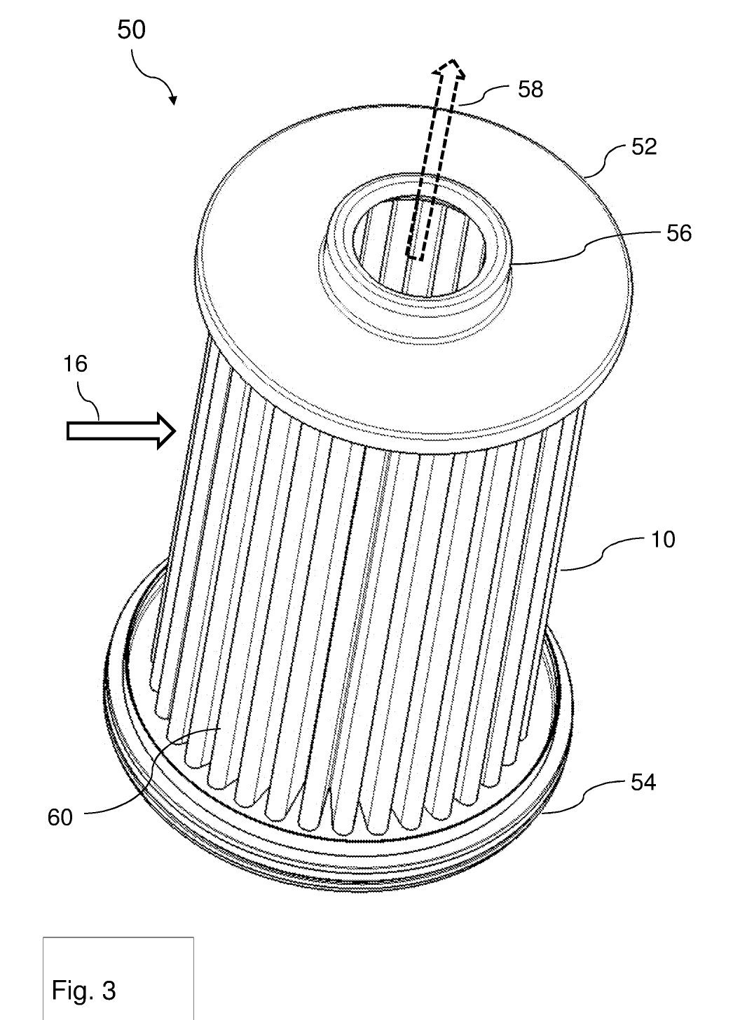

FIG. 3 shows a filter element with a pleated filter medium 10 according to a further exemplary embodiment of the invention. In this case the filter medium 10 is accordion-pleated and folded into a round body which is closed at both ends by a first 52 and a second end disc 54. These two end discs 52, 54 serve to accommodate and fix and also to seal the filter element 50 in a housing of a filter system. Fold edges 60, which lie parallel to a longitudinal direction of a support stratum 22 of the filter medium 10, can be clearly recognized on the external circumference of the round body of the filter medium 10, whilst a transverse direction of the support stratum 22 lies perpendicular thereto. The flow direction 16 of a fluid in the filter element 50 is radially inwards from the exterior into the round body of the filter medium 10, where the filtered fluid can then flow off again axially from the filter element 50 through an outlet 56 in in the outflow direction 58. In such an exemplary embodiment the filter element 50 can be used for example as a fuel filter of an internal combustion engine.

What is claimed is:

1. A filter medium, comprising:
a first layer of media;
a second layer of media; and
at least one third layer of media;
wherein the second layer of media is arranged behind the first layer of media (12) in an intended flow direction (16) of the filter medium;
wherein the third layer of media is arranged behind the second layer of media (18) in the intended flow direction (16) of the filter medium;
wherein the first layer of media has fibers, and wherein the second layer of media (18) has nanofibers.

2. The filter medium according to claim 1, wherein
the second layer of media has nanofibers with an average fiber diameter between 50 nm and 1,000 nm, and/or
the second layer of media is formed at least for the most part from nanofibers with an average fiber diameter between 50 nm and 1000 nm.

3. The filter medium according to claim 1, wherein
the second layer of media has a weight per unit area between 0.05 and 10 g/m².

4. The filter medium according to claim 1, wherein
the second layer of media is formed from electrospun nanofibers.

5. The filter medium according to claim 1, wherein
the second media layer is formed on the first layer or the third layer as a coating of nanofibers.

6. The filter medium according to claim 1, wherein
an average fiber diameter of the first layer of media is between 0.2 μm and 4 μm.

7. The filter medium according to claim 1 , wherein
at least 50% of the fibers in the first layer of media are glass fibers.

8. The filter medium according to claim 1,
wherein the first layer of media has a gradient structure of the packing density of the fibers with an increasing packing density in the intended flow direction.

9. The filter medium according to claim 1, wherein
the third layer of media has at least 50% of fibers formed as continuous fibers.

10. The filter medium according to claim 1, wherein
the third layer of media is formed from a meltblown layer, a spunbond layer or a cellulose layer.

11. The filter medium according to claim 1, wherein
the third layer of media includes at least one support stratum.

12. The filter medium according to claim 1, wherein
the third layer of media has a degree of deposition for particles having a particle size greater than 4 μm which is lower than a degree of precipitation for particles having a particle size greater than 4 μm of the first layer of media.

13. The filter medium according to claim 1, wherein
the third layer of media has a degree of precipitation for particles having a particle size greater than 4 pm, which is less than 60%.

14. The filter medium according to claim 1, wherein
the third layer of media has a thickness of at least 0.15 mm and at most 1.5 mm.

15. The filter medium according to claim 1, wherein
fibers in the third layer of media have an average fiber diameter of at least 1 μm and a maximum of 40 μm.

16. The filter medium according to claim 1, further comprising
a fourth layer of media;
wherein the fourth layer of media is arranged before the first layer of media in the intended flow direction and has a degree of deposition for particles having a particle size greater than 4 pm which is less than a degree of deposition of the first layer of media.

17. A filter element, comprising
a filter medium according to claim 1;
wherein the filter medium is a folded filter medium.

18. The filter element according to claim 17,
wherein the filter element is a fuel filter of an internal combustion engine.
